(19) United States
(12) Patent Application Publication
(10) Pub. No.: US 2026/0278323 A1
(43) Pub. Date: Sep. 17, 2026

(54) TARGET RANGE ANCHORING DEVICE AND METHOD

(71) Applicant: HTC Corporation, Taoyuan City (TW)

(72) Inventors: I-Fan CHUNG, Taoyuan City (TW); Rui-Hsiung TSAI, Taoyuan City (TW)

(21) Appl. No.: 19/565,542

(22) Filed: Mar. 13, 2026

Related U.S. Application Data
(60) Provisional application No. 63/770,998, filed on Mar. 13, 2025.

(51) Int. Cl. G06K 7/14

(52) U.S. Cl. CPC G06K 7/1417

(57) ABSTRACT

A target range anchoring device and method are provided. The device scans a to-be-judged image based on a first moving window to determine whether a first quick response code among at least one candidate quick response code is detected. In response to the first quick response code being detected, the device calculates first position information of the first quick response code to generate a transformation relationship corresponding to the first position information. The device calculates at least one target range corresponding to the first quick response code based on the transformation relationship corresponding to the first position information and the spatial position relationship between the first quick response code and a plurality of corner points.

### CROSS-REFERENCE TO RELATED APPLICATION

This application claims priority to U.S. Provisional Application Ser. No. 63/770,998, filed Mar. 13, 2025, which is herein incorporated by reference in its entirety.

### BACKGROUND

### Field of Invention

The present disclosure relates to a target range anchoring device and method. More particularly, the present disclosure relates to a target range anchoring device and method capable of accurately anchoring a target range.

### Description of Related Art

With the continuous development of image-related technologies, devices can perform image recognition and processing through computer vision (CV) technology, and execute various applications.

One such application could be to mark specific text blocks or image ranges in text, images, or environments to identify specific areas of a user's signature within text.

For example, in many application scenarios, users are required to sign on forms to confirm content and return images of the signed documents. In this example, the device needs to determine whether a user has signed within a specific range (e.g., whether the signature is correctly placed in a box) of a large number of document images (i.e., images to be judged) and the content of the signature.

However, the state of the image to be judged may be affected by factors such as lighting, angle, rotation, and distance during shooting, which can lead to the inability to accurately anchor a specific text or image range (e.g., poor lighting, skewed shooting angle, image rotation, image distance being too far or too close), resulting in incorrect recognition results.

Therefore, these problems increase the uncertainty of image recognition results during image recognition calculations, making it unusable in many commercial scenarios.

Accordingly, there is an urgent need for a target range anchoring technology that can accurately identify and calculate the target range.

### SUMMARY

An objective of the present disclosure is to provide a target range anchoring device. The target range anchoring device comprises a storage and a processor. The processor is electrically connected to the storage. The storage stores at least one candidate quick response code, a plurality of corner points corresponding to the at least one candidate quick response code, and a spatial positional relationship between the at least one candidate quick response code and each of the plurality of corner points. The processor scans a to-be-judged image based on a first moving window to determine whether a first quick response code among the at least one candidate quick response code is detected. In response to the first quick response code being detected, the processor calculates first position information of the first quick response code to generate a transformation relationship corresponding to the first position information. The processor calculates at least one target range corresponding to the first quick response code based on the transformation relationship corresponding to the first position information and the spatial position relationship between the first quick response code and each of the plurality of corner points.

Another objective of the present disclosure is to provide a target range anchoring method, which is adapted for use in an electronic device. The electronic device stores at least one candidate quick response code, a plurality of corner points corresponding to the at least one candidate quick response code, and a spatial positional relationship between the at least one candidate quick response code and each of the plurality of corner points. The target range anchoring method comprises the following steps: scanning a to-be-judged image based on a first moving window to determine whether a first quick response code among the at least one candidate quick response code is detected; in response to the first quick response code being detected, calculating first position information of the first quick response code to generate a transformation relationship corresponding to the first position information; and calculating at least one target range corresponding to the first quick response code based on the transformation relationship corresponding to the first position information and the spatial position relationship between the first quick response code and each of the plurality of corner points.

According to the above descriptions, the target range anchoring technology provided by the present disclosure (at least including the device and the method) can detect quick response codes in an image by scanning an image to be judged through a moving window. Then, the device determines the positional information of the quick response codes to generate a corresponding positional information transformation relationship. Finally, the device can accurately calculate the target range corresponding to the quick response codes based on pre-stored spatial positional relationships and transformation relationships. Furthermore, the target range anchoring technology disclosed herein can detect quick response codes in an image by setting different sized moving windows and scanning the image to be judged through a downsizing mechanism, thus avoiding the omission of undetected quick response codes. In addition, the scanning mechanism provided by the target range anchoring technology disclosed herein can still correctly detect multiple quick response codes even when the image to be judged contains multiple quick response codes, solving the problem of incorrect target range anchoring in the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a document of some embodiments;

FIG. 2 is a schematic view depicting quick response codes and target ranges of some embodiments;

FIG. 3 is a schematic view depicting a target range anchoring device of some embodiments;

FIG. 4 is a schematic view depicting the spatial position relationships of some embodiments;

FIG. 5 is a schematic view depicting a quick response code of some embodiments;

FIG. 6 is a schematic view depicting operations of a moving window of some embodiments; and

FIG. 7 is a partial flowchart depicting a target range anchoring method of the second embodiment.

### DETAILED DESCRIPTION

In the following description, a target range anchoring device and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

The following paragraphs first explain the problem and environment that this disclosure aims to address. In the application environment of this disclosure, the target range anchoring operation provided by this disclosure can be performed by printing or posting images capable of performing anchoring tasks (e.g., quick-response codes; QR codes) in various paper and real environments.

For example, this disclosure provides a variety of documents with anchors for users to interact with (e.g., allowing users to sign or check options). After signing a document (e.g., a paper document or an electronic document), the user may take a picture of the signed document and transmit it to a database or the device disclosed herein, whereby the device disclosed performs target range anchoring operations (e.g., confirming the content of a specific signature range in the document).

It shall be appreciated that if there are anchors in the text or environment that can be accurately detected, the range of text or images around them can be deduced by the distance, size and rotation angle of the anchors themselves.

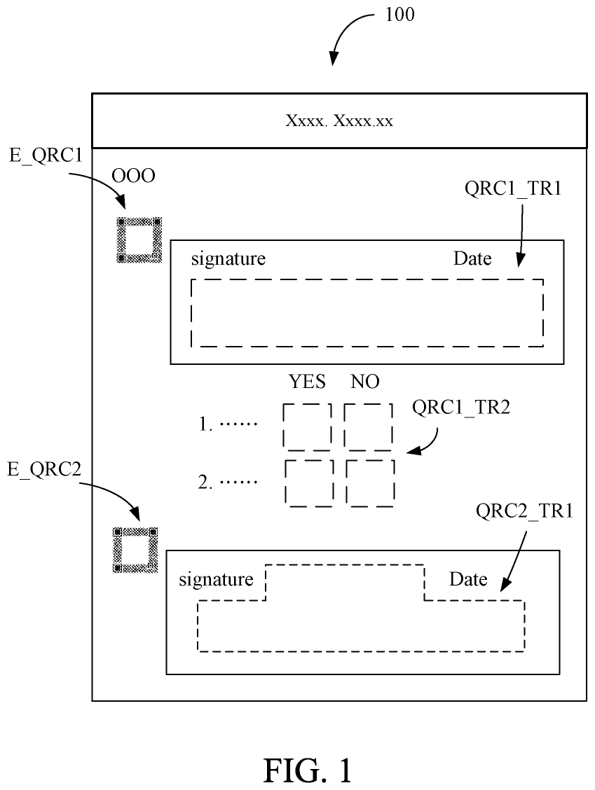

For ease of understanding, please refer to the document diagram 100 in FIG. 1. In this example, the document contains the quick response code E_QRC1 and the quick response code E_QRC2. The quick response code E_QRC1 corresponds to the target range QRC1_TR1 and the target range QRC1_TR2 (e.g., the signature area and four options). The quick response code E_QRC2 corresponds to the target range QRC2_TR1 (e.g., the signature area).

The target range anchoring mechanism disclosed herein can accurately calculate the corresponding correct target range positions of each different quick response code in an image by identifying the position and status of these anchors (e.g., the quick response codes) in the image. Accordingly, when subsequent applications require the use of target range content information (e.g., confirming whether the signature is within the range, whether the content is correct), the image recognition and other operations can be performed correctly.

It shall be appreciated that, since the relative position of the quick response code and the target range is fixed (i.e., it has a fixed distance, direction, scale, etc.), this disclosure can accurately obtain the position of the target range in the image by identifying the state of the quick response code (e.g., position, rotation angle, and size).

Furthermore, after the correct target range is generated in this disclosure, the text content (e.g., options, signature) in the target range can be detected by optical recognition algorithms in subsequent applications to correspond to different operations.

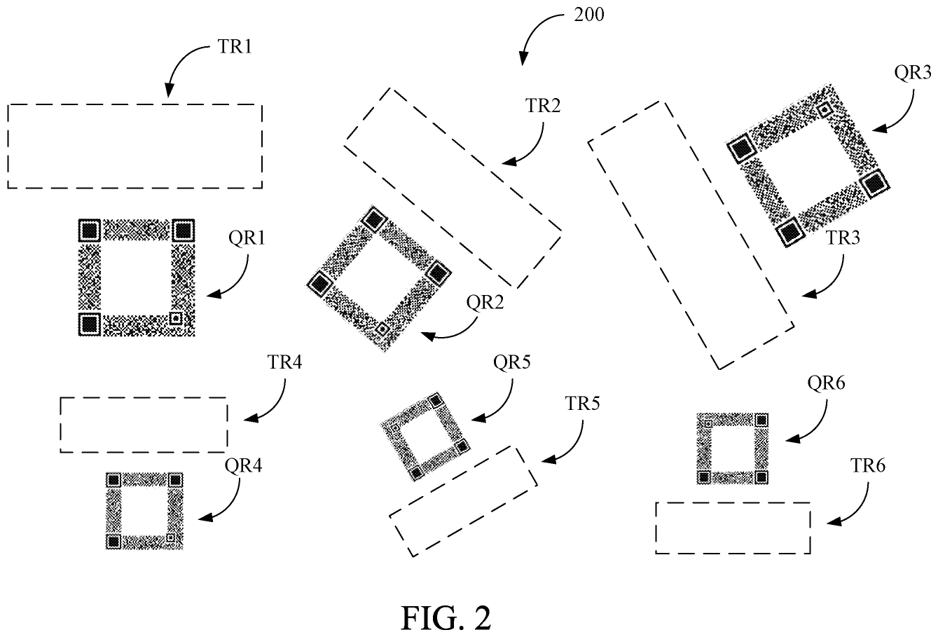

For ease of understanding, please refer to FIG. 2. FIG. 2 illustrates several quick response codes and target ranges in diagram 200. In this example, the diagram 200 includes six diagrams: the first set of the quick response code QR1 and the target range TR1; the second set of the quick response code QR2 and the target range TR2; the third set of the quick response code QR3 and the target range TR3; the fourth set of the quick response code QR4 and the target range TR4; the fifth set of the quick response code QR5 and the target range TR5; and the sixth set of the quick response code QR6 and the target range TR6.

In this example, different sets illustrate states such as zooming and rotation, to simulate situations where the actual image is not taken from a normal distance or angle. For example, the first set is the quick response code and the target range in a normal position. The second set is the quick response code and the target range rotated 45 degrees to the right. The fourth set is the quick response code and the target range when photographed from a distance. The sixth set is the quick response code and the target range upside down.

It shall be appreciated that, for ease of explanation, FIG. 2 only illustrates the cases of rotation and different sizes in two-dimensional space. In some practical situations, the quick response code and the target range may also be deformed in three-dimensional space due to different shooting angles (e.g., shooting from a side angle). Subsequent paragraphs will explain in detail how the mechanism provided in this disclosure can correctly identify and generate the corresponding target range.

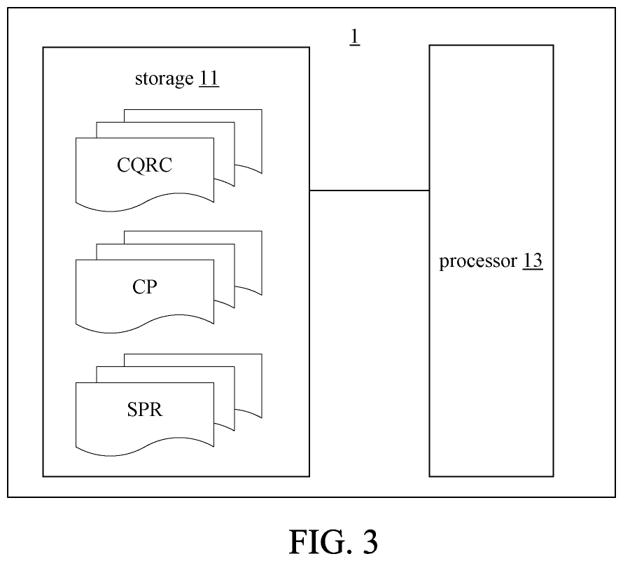

The operations of this disclosure will be described in detail below. The first embodiment of this disclosure is a target range anchoring device 1, the schematic diagram of which is shown in FIG. 3. The target range anchoring device 1 includes a storage 11 and a processor 13, the processor 13 being electrically connected to the storage 11.

It shall be appreciated that the storage 11 may be a memory, a Universal Serial Bus (USB) disk, a hard disk, a Compact Disk (CD), a mobile disk, or any other storage medium or circuit known to those of ordinary skill in the art and having the same functionality. The processor 13 may be any of various processors, Central Processing Units (CPUs), microprocessors, digital signal processors or other computing devices known to those of ordinary skill in the art.

In some embodiments, the target range anchoring device 1 may be an electronic device that performs image recognition (e.g., a to-be-judged image). For example, the to-be-judged image may be an image of a document signed by a user, and the target range (e.g., a specific signature range in the document) is correctly extracted by the target range anchoring device 1.

In some embodiments, the target range anchoring device 1 may be an electronic device with scanning function (e.g., a quick response code scanner implemented by hardware or software).

In the present embodiment, as shown in FIG. 3, the storage 11 stores one or more candidate quick response codes CQRC, such as: a first quick response code, a second quick response code, . . . , an nth quick response code, where n is a positive integer.

In addition, the storage 11 stores a plurality of corner points CP corresponding to each candidate quick response code CQRC (e.g., the vertex positions of each target range) and the spatial positional relationship SPR between each candidate quick response code CQRC and each of the corner points CP.

It shall be appreciated that the spatial position relationship SPR can be any information that can record the positional relationship between the candidate quick response code CQRC and the corresponding corner points CP. For example, the spatial position relationship SPR can record the relative relationships, such as distance, orientation, and angle, etc., between each corner point CP of a target range and the candidate quick response code CQRC within the same set.

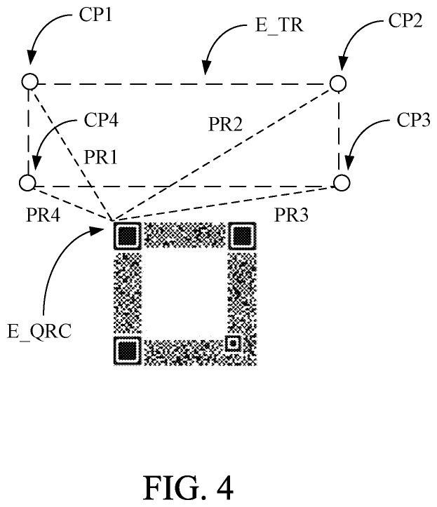

For ease of understanding, please refer to FIG. 4. In this example, the spatial positional relationship SPR stored in storage 11 can be the positional relationship PR1, PR2, PR3, and PR4 between each corner point CP1, CP2, CP3, and CP4 in the target range E_TR and the vertex of the upper left corner of the quick response code E_QRC. For example, the positional relationship PR1 can be defined as extending X distance to the left and Y distance upward from the top left vertex of the quick response code E_QRC.

In other words, if we extend X distance to the left and Y distance upward from the vertex of the upper left corner of the quick response code E_QRC, we can obtain the corner point CP1 of the target region E_TR.

It shall be appreciated that this disclosure can determine the direction, rotation angle, and size of the quick response code by identifying the vertices of the quick response code. Therefore, this disclosure can store the positional relationship of the normal orientation in the storage 11, and determine the offset correction information by calculating the direction, rotation angle, size, and other information of the quick response code.

The target range anchoring device 1 disclosed herein can detect one or more quick response codes in an image and calculate the corresponding one or more target ranges through various mechanisms. The operational details of the target range anchoring device 1 disclosed herein will be explained in detail below.

First, in the present embodiment, the processor 13 scans a to-be-judged image based on a first moving window to determine whether a first quick response code among the at least one candidate quick response code is detected.

For example, the moving window can be a window of a preset size (e.g., one-tenth of the image size), and the processor 13 can scan different areas from left to right and from top to bottom by translating a partial distance each time.

In some embodiments, this algorithm identifies multiple quick response codes through multiple scans. After detecting a quick response code, the processor 13 erases it to ensure that other quick response codes can be detected in the next scan.

In some embodiments, the processor 13 may update the to-be-judged image to exclude regions of quick response codes that have already been detected (e.g., erasure or fade operation). Specifically, in response to the first quick response code being detected, the processor 13 erases a region corresponding to the first quick response code on the to-be-judged image to update the to-be-judged image.

In some embodiments, when the processor 13 does not detect a quick response code in the area of the currently moving window, it can perform a displacement operation of the moving window to move to the next area for scanning. Specifically, the processor 13 scans a first region in the to-be-judged image at a first time point based on the first moving window. Then, in response to the first quick response code not being detected in the first region, the processor 13 moves the first moving window to scan a second region in the to-be-judged image at a second time point.

In some embodiments, to avoid missing quick response codes at the boundary, the processor 13 needs to limit the overlapping area with a certain proportion when moving. Specifically, the second region has a preset overlap ratio with the first region, and the second time point is later than the first time point.

In some embodiments, since the same region may have multiple quick response codes, the processor 13 may pause the movement of the moving window when a quick response code is detected in the region to confirm whether there are other quick response codes. Specifically, the processor 13 scans a first region in the to-be-judged image at a first time point based on the first moving window. Then, in response to the first quick response code being detected in the first region, the processor 13 stops moving the first moving window. Next, the processor 13 scans the first region in the to-be-judged image at a second time point, wherein the second time point is later than the first time point.

Next, in the present embodiment, in response to the first quick response code being detected, the processor 13 calculates first position information of the first quick response code to generate a transformation relationship corresponding to the first position information.

In some embodiments, the transformation relationship can be represented by a transformation matrix. The processor 13 can use the transformation matrix to transfer each original coordinate position to a new coordinate position. In some embodiments, the processor 13 can calculate the transformation matrix between the camera and the object through perspective transformation or pose estimation, and the processor 13 can deduce the actual position of the original coordinate position on the image through the transformation matrix.

It shall be appreciated that the processor 13 can determine the size, rotation, deformation, and other state information of the quick response code by confirming its position information in the image. Then, the processor 13 can generate a corresponding transformation relationship based on the state information, which can be used to proportionally correct the position of the target range.

In some embodiments, the processor 13 can calculate new coordinates using the quick response code as an anchor point for positioning, based on the calculated position information of the quick response code and the stored relative position of the target image.

For example, the processor 13 first anchors the top-left corner of the quick response code as the origin of the coordinate axis (0, 0). Next, the processor 13 finds the relative distance of the target region to the top-left corner of the quick response code; for example, the displacement vector of the top-left corner is (−10, 12.5). Then, the processor 13 converts the displacement vector of the target corner point into units of the width and height of the quick response code itself; for example, the original (−10, 12.5) is converted to (−0.32 W_{TOP}, 0.49H_{left}), where W_{TOP} is the top width of the quick response code and H_{left} is the left height of the quick response code.

Accordingly, the processor 13 can obtain the distance of each position in the target region relative to the quick response code, expressed in units of the size of the quick response code itself. Next, in subsequent applications, the scanned quick response code is obtained, and its size and rotation angle are calculated. Then, the displacement vector at each position is extended and rotated to calculate the new coordinate point.

In some embodiments, the quick response code may undergo deformation states such as rotation and size changes in two-dimensional space. The processor 13 can calculate the state of the quick response code using the coordinates of each corner point, and calculate the transformation relationship based on the deformation state.

For example, the processor 13 calculates a rotation angle or a scaling factor corresponding to a two-dimensional spatial coordinate based on a plurality of code coordinates of the first quick response code. Then, the processor 13 calculates the transformation relationship based on the rotation angle or the scaling factor.

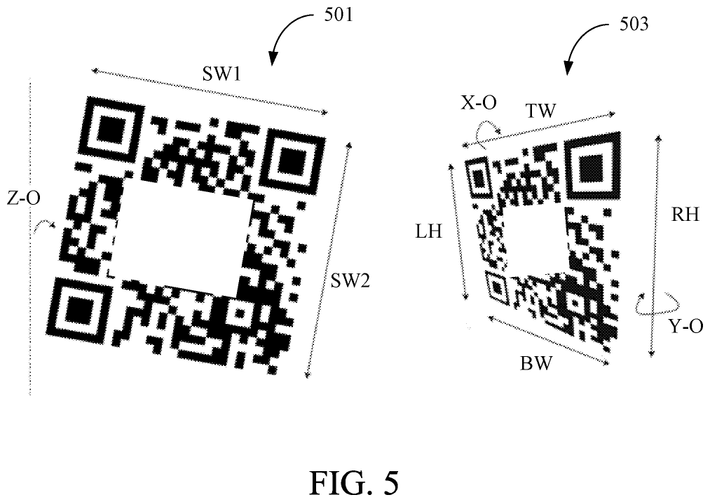

For ease of understanding, please refer to the quick response code schematic diagram 501 in FIG. 5. In this example, the processor 13 can calculate the rotation angle of the quick response code in the coordinate axis orientation Z-O based on the code coordinates of the quick response code. In this example, since the lengths of the two side widths SW1 and SW2 do not change (i.e., the lengths are symmetrical), the processor 13 determines that the quick response code rotates only in two-dimensional space.

In some embodiments, the quick response code may undergo deformation in three-dimensional space. The processor 13 can calculate the deformation state of the quick response code through the side lengths of each side of the quick response code, and calculate the transformation relationship based on the deformation state.

Specifically, the processor 13 calculates a plurality of side widths (e.g., the lengths of the top, bottom, left, and right sides) of the first quick response code based on a plurality of code coordinates. Then, the processor 13 calculates a skew angle of the first quick response code corresponding to a three-dimensional spatial coordinate based on the plurality of side widths of the first quick response code. Next, the processor 13 calculates the transformation relationship based on the skew angle.

For ease of understanding, please refer to the quick response code schematic diagram 503 in FIG. 5. In this example, the processor 13 can calculate the top width TW, the bottom width BW, the right height RH, and the left height LH of the quick response code based on its code coordinates. Then, the processor 13 calculates the rotation angle of the quick response code in the X-O and Y-O coordinate axis orientations based on the top width TW, the bottom width BW, the right height RH, and the left height LH. In this example, since the width and height on both sides change in length, the processor 13 determines that the quick response code is rotating in three-dimensional space.

It shall be appreciated that the processor 13 can determine the skew angle of the image by the change in the edge width, and calculate the transformation relationship based on the same deformation relationship.

Next, in this embodiment, the processor 13 calculates at least one target range corresponding to the first quick response code based on the transformation relationship corresponding to the first position information and the spatial position relationship between the first quick response code and each of the plurality of corner points.

It shall be appreciated that since the spatial relationship between the corner points of the target range and the quick response code is fixed, the processor 13 can proportionally transform the original position of the target range by calculating the deformation state of the quick response code, so as to obtain the correct target range position on the image.

In some embodiments, since the size of the quick response code may vary, the processor 13 can scan the to-be-judged image by shrinking or enlarging the size of the moving window to avoid missing quick response codes on the to-be-judged image. For example, the quick response code may be too small for the quick response code scanner to detect correctly. In addition, if the size of the quick response code is too large and exceeds the size of the moving window, the quick response code scanner may be unable to detect it correctly.

Specifically, when the size of the quick response code is too small, the processor 13, in response to the first quick response code not being detected, scans the to-be-judged image based on a second moving window to determine whether the first quick response code is detected, wherein a window size of the second moving window is smaller than the window size of the first moving window. Then, in response to the first quick response code being detected, the processor 13 calculates the first position information of the first quick response code to generate the transformation relationship corresponding to the first position information.

Specifically, when the size of the quick response code is too large, the processor 13, in response to the first quick response code not being detected, scans the to-be-judged image based on a second moving window to determine whether the first quick response code is detected, wherein a window size of the second moving window is larger than the window size of the first moving window. Then, in response to the first quick response code being detected, the processor 13 calculates the first position information of the first quick response code to generate the transformation relationship corresponding to the first position information.

In some embodiments, the processor 13 may set a size reduction rule to gradually decrease the size of the moving window. Specifically, the processor 13 performs a size adjustment operation on the first moving window based on a scale degradation rule to generate the second moving window. For example, the processor 13 may perform the size adjustment operation of the moving window by decreasing the window size by half each time.

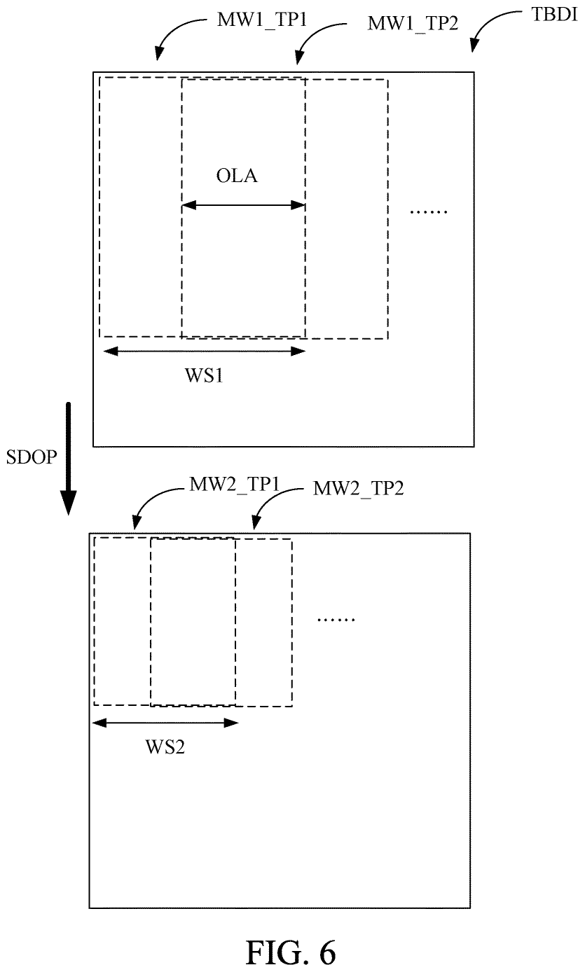

For ease of understanding, please refer to the schematic diagram of the moving window operations in FIG. 6. In this example, the target range anchoring device 1 receives and processes the to-be-judged image TBDI. The processor 13 scans the position of the first moving window MW1_TP1 at a first time point based on the moving window corresponding to the window size WS1. Then, the processor 13 scans the position of the first moving window MW1_TP2 at a second time point, and so on at other time points. The first moving window MW1_TP1 at the first time point and the first moving window MW1_TP2 at the second time point have an overlapping area OLA.

Next, the processor 13 performs a scale degrade operation SDOP to generate a moving window of a new window size. In this example, the processor 13 scans the position of the second moving window MW2_TP1 at a first time point based on the moving window corresponding to the window size WS2. Then, the processor 13 scans the position of the second moving window MW2_TP2 at a second time point, and so on at other time points.

In some embodiments, to avoid ineffective resource waste due to an excessively small window size, the window size of the second moving window is not less than a minimum preset window size value.

In some embodiments, the processor 13 may determine a plurality of quick response codes in the to-be-judged image. Specifically, the processor 13 scans the to-be-judged image based on the first moving window to determine whether a second quick response code among the at least one candidate quick response code is detected. Then, in response to the second quick response code being detected, the processor 13 calculates second position information of the second quick response code to generate the transformation relationship corresponding to the second position information. Then, the processor 13 calculates the at least one target range corresponding to the second quick response code based on the transformation relationship corresponding to the second position information and the spatial position relationship between the second quick response code and each of the plurality of corner points.

In some embodiments, the processor 13 may determine whether to continue the target range anchoring operation based on a preset code quantity corresponding to the document (e.g., how many quick response codes the document has). Specifically, the storage 11 further stores a preset code quantity. The processor 13 determines whether a detected quick response code quantity from the to-be-judged image is lower than the preset code quantity. Then, in response to the detected quick response code quantity being lower than the preset code quantity, the processor 13 performs a target range anchoring operation.

In some embodiments, the processor 13 may perform target range anchoring operations until the number of detected quick response codes equals the preset code quantity.

It shall be appreciated that in the prior art, when there are multiple quick response codes in the environment or on paper, all currently available quick response code scanners can only detect one and cannot capture all anchors. This disclosure solves this problem through the aforementioned operation.

Furthermore, when the quick response code occupies a small portion of the image (e.g., less than 10% of the image in length and width), it cannot be detected by commercially available quick response code scanners, even if the image itself is clear enough. This disclosure solves this problem through the aforementioned moving window size adjustment operation.

In some embodiments, the target range anchoring device 1 can perform the target range anchoring operation by receiving input images, PDF files, photos, etc.

In some embodiments, the target range anchoring device 1 further includes a camera. The target range anchoring device 1 can directly detect the quick response code and generate the target ranges by taking pictures or streaming (e.g., frame-by-frame judgment).

According to the above descriptions, the target range anchoring device 1 provided by the present disclosure can detect quick response codes in an image by scanning an image to be judged through a moving window. Then, the target range anchoring device 1 determines the positional information of the quick response codes to generate a corresponding positional information transformation relationship. Finally, the target range anchoring device 1 can accurately calculate the target range corresponding to the quick response codes based on pre-stored spatial positional relationships and transformation relationships. Furthermore, the target range anchoring device 1 disclosed herein can detect quick response codes in an image by setting different sized moving windows and scanning the image to be judged through a downsizing mechanism, thus avoiding the omission of undetected quick response codes. In addition, the scanning mechanism provided by the target range anchoring device 1 disclosed herein can still correctly detect multiple quick response codes even when the image to be judged contains multiple quick response codes, solving the problem of incorrect target range anchoring in the prior art.

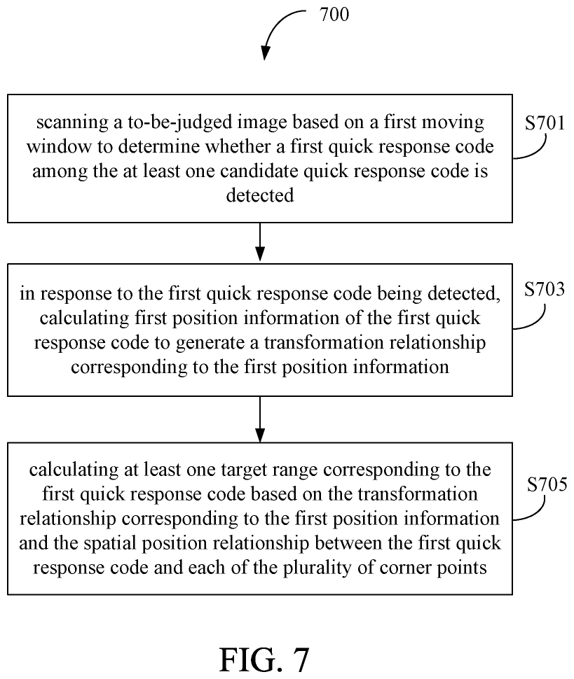

A second embodiment of the present invention is a target range anchoring method and a flowchart thereof is depicted in FIG. 7. The target range anchoring method 700 is adapted for use in an electronic device (e.g., the target range anchoring device 1 of the first embodiment). The electronic device stores at least one candidate quick response code, a plurality of corner points corresponding to the at least one candidate quick response code, and a spatial positional relationship between the at least one candidate quick response code and each of the plurality of corner points. The target range anchoring method 700 calculates at least one target range corresponding to the first quick response code through the steps S701 to S705.

First, in the step S701, the electronic device scans a to-be-judged image based on a first moving window to determine whether a first quick response code among the at least one candidate quick response code is detected.

Next, in the step S703, in response to the first quick response code being detected, the electronic device calculates first position information of the first quick response code to generate a transformation relationship corresponding to the first position information.

Finally, in the step S705, the electronic device calculates at least one target range corresponding to the first quick response code based on the transformation relationship corresponding to the first position information and the spatial position relationship between the first quick response code and each of the plurality of corner points.

In some embodiments, wherein the step of scanning the to-be-judged image based on the first moving window comprises the following steps: scanning a first region in the to-be-judged image at a first time point based on the first moving window; and in response to the first quick response code not being detected in the first region, moving the first moving window to scan a second region in the to-be-judged image at a second time point, wherein the second region has a preset overlap ratio with the first region, and the second time point is later than the first time point.

In some embodiments, wherein the step of scanning the to-be-judged image based on the first moving window comprises the following steps: scanning a first region in the to-be-judged image at a first time point based on the first moving window; in response to the first quick response code being detected in the first region, stopping a movement of the first moving window; and scanning the first region in the to-be-judged image at a second time point, wherein the second time point is later than the first time point.

In some embodiments, wherein the electronic device further performs the following steps: calculating a plurality of side widths of the first quick response code based on a plurality of code coordinates of the first quick response code; calculating a skew angle of the first quick response code corresponding to a three-dimensional spatial coordinate based on the plurality of side widths of the first quick response code; and calculating the transformation relationship based on the skew angle.

In some embodiments, wherein the electronic device further performs the following steps: calculating a rotation angle of the first quick response code corresponding to a two-dimensional spatial coordinates based on a plurality of code coordinates of the first quick response code; and calculating the transformation relationship based on the rotation angle.

In some embodiments, wherein the target range anchoring method 700 further comprises the following steps: in response to the first quick response code not being detected, scanning a to-be-judged image based on a second moving window to determine whether the first quick response code is detected, wherein a window size of the second moving window is smaller than the window size of the first moving window; and in response to the first quick response code being detected, calculating the first position information of the first quick response code to generate the transformation relationship corresponding to the first position information.

In some embodiments, wherein the target range anchoring method 700 further comprises the following steps: performing a size adjustment operation on the first moving window based on a scale degradation rule to generate the second moving window, wherein the window size of the second moving window is not less than a minimum preset window size value.

In some embodiments, wherein the target range anchoring method 700 further comprises the following steps: scanning the to-be-judged image based on the first moving window to determine whether a second quick response code among the at least one candidate quick response code is detected; in response to the second quick response code being detected, calculating second position information of the second quick response code to generate the transformation relationship corresponding to the second position information; and calculating the at least one target range corresponding to the second quick response code based on the transformation relationship corresponding to the second position information and the spatial position relationship between the second quick response code and each of the plurality of corner points.

In some embodiments, wherein the electronic device further stores a preset code quantity, and the target range anchoring method 700 further comprises the following steps: determining whether a detected quick response code quantity from the to-be-judged image is lower than the preset code quantity; and in response to the detected quick response code quantity being lower than the preset code quantity, performing a target range anchoring operation.

In some embodiments, wherein the target range anchoring method 700 further comprises the following steps: in response to the first quick response code being detected, erasing a region corresponding to the first quick response code on the to-be-judged image to update the to-be-judged image.

In addition to the aforesaid steps, the second embodiment can also execute all the operations and steps of the target range anchoring device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The target range anchoring method described in the second embodiment may be implemented by a computer program having a plurality of codes. The computer program may be a file that can be transmitted over the network, or may be stored into a non-transitory computer readable storage medium. After the codes of the computer program are loaded into an electronic apparatus (e.g., the target range anchoring device 1), the computer program executes the target range anchoring method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present invention, some words (e.g., the moving window, the quick response code, the position information, the time point, the region, etc.) are preceded by terms such as “first” or “second”, and these terms of “first” or “second” are only used to distinguish these different words. For example, the “first” and “second” in the first quick response code and the second quick response code are only used to indicate the different quick response code.

According to the above descriptions, the target range anchoring technology provided by the present disclosure (at least including the device and the method) can detect quick response codes in an image by scanning an image to be judged through a moving window. Then, the device determines the positional information of the quick response codes to generate a corresponding positional information transformation relationship. Finally, the device can accurately calculate the target range corresponding to the quick response codes based on pre-stored spatial positional relationships and transformation relationships. Furthermore, the target range anchoring technology disclosed herein can detect quick response codes in an image by setting different sized moving windows and scanning the image to be judged through a downsizing mechanism, thus avoiding the omission of undetected quick response codes. In addition, the scanning mechanism provided by the target range anchoring technology disclosed herein can still correctly detect multiple quick response codes even when the image to be judged contains multiple quick response codes, solving the problem of incorrect target range anchoring in the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A target range anchoring device, comprising:
a storage, storing at least one candidate quick response code, a plurality of corner points corresponding to the at least one candidate quick response code, and a spatial positional relationship between the at least one candidate quick response code and each of the plurality of corner points; and
a processor, being electrically connected to the storage, and being configured to perform operations comprising:
scanning a to-be-judged image based on a first moving window to determine whether a first quick response code among the at least one candidate quick response code is detected;
in response to the first quick response code being detected, calculating first position information of the first quick response code to generate a transformation relationship corresponding to the first position information; and
calculating at least one target range corresponding to the first quick response code based on the transformation relationship corresponding to the first position information and the spatial position relationship between the first quick response code and each of the plurality of corner points.

2. The target range anchoring device of claim 1, wherein the operation of scanning the to-be-judged image based on the first moving window comprises the following operations:
scanning a first region in the to-be-judged image at a first time point based on the first moving window; and
in response to the first quick response code not being detected in the first region, moving the first moving window to scan a second region in the to-be-judged image at a second time point, wherein the second region has a preset overlap ratio with the first region, and the second time point is later than the first time point.

3. The target range anchoring device of claim 1, wherein the operation of scanning the to-be-judged image based on the first moving window comprises the following operations:
scanning a first region in the to-be-judged image at a first time point based on the first moving window; and
in response to the first quick response code being detected in the first region, stopping a movement of the first moving window; and
scanning the first region in the to-be-judged image at a second time point, wherein the second time point is later than the first time point.

4. The target range anchoring device of claim 1, wherein the target range anchoring device further performs the following operations:
calculating a plurality of side widths of the first quick response code based on a plurality of code coordinates of the first quick response code;
calculating a skew angle of the first quick response code corresponding to a three-dimensional spatial coordinate based on the plurality of side widths of the first quick response code; and
calculating the transformation relationship based on the skew angle.

5. The target range anchoring device of claim 1, wherein the target range anchoring device further performs the following operations:
calculating a rotation angle of the first quick response code corresponding to a two-dimensional spatial coordinates based on a plurality of code coordinates of the first quick response code; and
calculating the transformation relationship based on the rotation angle.

6. The target range anchoring device of claim 1, wherein the processor further performs the following operations:
in response to the first quick response code not being detected, scanning the to-be-judged image based on a second moving window to determine whether the first quick response code is detected, wherein a window size of the second moving window is smaller than the window size of the first moving window; and
in response to the first quick response code being detected, calculating the first position information of the first quick response code to generate the transformation relationship corresponding to the first position information.

7. The target range anchoring device of claim 6, wherein the processor further performs the following operations:
performing a size adjustment operation on the first moving window based on a scale degradation rule to generate the second moving window, wherein the window size of the second moving window is not less than a minimum preset window size value.

8. The target range anchoring device of claim 1, wherein the processor further performs the following operations:
scanning the to-be-judged image based on the first moving window to determine whether a second quick response code among the at least one candidate quick response code is detected;
in response to the second quick response code being detected, calculating second position information of the second quick response code to generate the transformation relationship corresponding to the second position information; and
calculating the at least one target range corresponding to the second quick response code based on the transformation relationship corresponding to the second position information and the spatial position relationship between the second quick response code and each of the plurality of corner points.

9. The target range anchoring device of claim 1, wherein the storage further stores a preset code quantity, and the processor further performs the following operations:
determining whether a detected quick response code quantity from the to-be-judged image is lower than the preset code quantity; and
in response to the detected quick response code quantity being lower than the preset code quantity, performing a target range anchoring operation.

10. The target range anchoring device of claim 1, wherein the target range anchoring device further performs the following operations:
in response to the first quick response code being detected, erasing a region corresponding to the first quick response code on the to-be-judged image to update the to-be-judged image.

11. A target range anchoring method, being adapted for use in an electronic device, wherein the electronic device stores at least one candidate quick response code, a plurality of corner points corresponding to the at least one candidate quick response code, and a spatial positional relationship between the at least one candidate quick response code and each of the plurality of corner points, and the target range anchoring method comprises the following steps:
scanning a to-be-judged image based on a first moving window to determine whether a first quick response code among the at least one candidate quick response code is detected;
in response to the first quick response code being detected, calculating first position information of the first quick response code to generate a transformation relationship corresponding to the first position information; and
calculating at least one target range corresponding to the first quick response code based on the transformation relationship corresponding to the first position information and the spatial position relationship between the first quick response code and each of the plurality of corner points.

12. The target range anchoring method of claim 11, wherein the step of scanning the to-be-judged image based on the first moving window comprises the following steps:
scanning a first region in the to-be-judged image at a first time point based on the first moving window; and
in response to the first quick response code not being detected in the first region, moving the first moving window to scan a second region in the to-be-judged image at a second time point, wherein the second region has a preset overlap ratio with the first region, and the second time point is later than the first time point.

13. The target range anchoring method of claim 11, wherein the step of scanning the to-be-judged image based on the first moving window comprises the following steps:
scanning a first region in the to-be-judged image at a first time point based on the first moving window;
in response to the first quick response code being detected in the first region, stopping a movement of the first moving window; and
scanning the first region in the to-be-judged image at a second time point, wherein the second time point is later than the first time point.

14. The target range anchoring method of claim 11, wherein the electronic device further performs the following steps:
calculating a plurality of side widths of the first quick response code based on a plurality of code coordinates of the first quick response code;
calculating a skew angle of the first quick response code corresponding to a three-dimensional spatial coordinate based on the plurality of side widths of the first quick response code; and
calculating the transformation relationship based on the skew angle.

15. The target range anchoring method of claim 11, wherein the electronic device further performs the following steps:
calculating a rotation angle of the first quick response code corresponding to a two-dimensional spatial coordinates based on a plurality of code coordinates of the first quick response code; and
calculating the transformation relationship based on the rotation angle.

16. The target range anchoring method of claim 11, wherein the target range anchoring method further comprises the following steps:
in response to the first quick response code not being detected, scanning a to-be-judged image based on a second moving window to determine whether the first quick response code is detected, wherein a window size of the second moving window is smaller than the window size of the first moving window; and
in response to the first quick response code being detected, calculating the first position information of the first quick response code to generate the transformation relationship corresponding to the first position information.

17. The target range anchoring method of claim 16, wherein the target range anchoring method further comprises the following steps:
performing a size adjustment operation on the first moving window based on a scale degradation rule to generate the second moving window, wherein the window size of the second moving window is not less than a minimum preset window size value.

18. The target range anchoring method of claim 11, wherein the target range anchoring method further comprises the following steps:
scanning the to-be-judged image based on the first moving window to determine whether a second quick response code among the at least one candidate quick response code is detected;
in response to the second quick response code being detected, calculating second position information of the second quick response code to generate the transformation relationship corresponding to the second position information; and
calculating the at least one target range corresponding to the second quick response code based on the transformation relationship corresponding to the second position information and the spatial position relationship between the second quick response code and each of the plurality of corner points.

19. The target range anchoring method of claim 11, wherein the electronic device further stores a preset code quantity, and the target range anchoring method further comprises the following steps:
determining whether a detected quick response code quantity from the to-be-judged image is lower than the preset code quantity; and
in response to the detected quick response code quantity being lower than the preset code quantity, performing a target range anchoring operation.

20. The target range anchoring method of claim 11, wherein the target range anchoring method further comprises the following steps:
in response to the first quick response code being detected, erasing a region corresponding to the first quick response code on the to-be-judged image to update the to-be-judged image.
